(19) United States
(12) Patent Application Publication
(10) Pub. No.: US 2026/0074405 A1
(43) Pub. Date: Mar. 12, 2026

(54) BATTERY ASSEMBLY AND BATTERY SYSTEM INCLUDING THE SAME

(71) Applicant: SAMSUNG SDI CO., LTD., Yongin-Si Gyeonggi-do (KR)

(72) Inventor: Taejin KIM, Yongin-Si (KR)

(21) Appl. No.: 19/073,979

(22) Filed: Mar. 7, 2025

(30) Foreign Application Priority Data
Sep. 10, 2024 (KR) 10-2024-0123031

(51) Int. Cl. H01M 50/673; A62C 3/16; A62C 37/40; H01M 10/42; H01M 10/48; H01M 50/204

(52) U.S. Cl. CPC H01M 50/673; A62C 3/16; A62C 37/40; H01M 10/425; H01M 10/482; H01M 10/486; H01M 50/204; H01M 2010/4271

(57) ABSTRACT

A battery assembly including a case having an accommodation space formed therein; a plurality of cells positioned in the accommodation space and aligned in one direction; a plurality of sensors configured to measure at least one of voltage or temperature of at least some of the cells; a fire extinguishing pipe connected to a fire extinguishing device, at least a part of the fire extinguishing pipe being positioned in the accommodation space; a heating member positioned adjacent to the fire extinguishing pipe; and a controller configured to control a power source to apply current to the heating member based on information associated with the cells received from the sensors.

### CROSS-REFERENCE TO RELATED APPLICATION

The present application claims priority to and the benefit of Korean Application No. 10-2024-0123031, filed on Sep. 10, 2024, in the Korean Intellectual Property Office, the entire disclosure of which is incorporated herein by reference.

### BACKGROUND

### 1. Field

Aspects of embodiments of the present disclosure relate to a battery assembly and battery system including the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An energy storage system (ESS) may refer to a system that stores produced electric energy by using lithium-ion batteries, etc., and then allows the electric energy to be used in a case of being needed. The ESS enable energy to be utilized efficiently at all stages of power generation, transmission, substation, distribution and reception.

A battery assembly used in an ESS may include a plurality of lithium-ion batteries. Lithium-ion batteries are energy-efficient, but pose a higher fire risk than nickel-cadmium batteries or nickel-hydrogen batteries. In a case where thermal runaway occurs in the lithium-ion batteries, it may result in fire or explosion and may spread to adjacent battery cells. In the event of a thermal runaway transition, there is the problem that it is difficult to extinguish the fire due to the high fire intensity and risk of subsequent explosion.

The above information disclosed in this Background section is for enhancement of understanding of the background of the present disclosure, and therefore, it may contain information that does not constitute related (or prior) art.

### SUMMARY

Aspects of some embodiments of the present disclosure are directed to a battery assembly and battery system including the same.

These and other aspects and features of the present disclosure will be described in or will be apparent from the following description of embodiments of the present disclosure.

According to some embodiments of the present disclosure, there is provided a battery assembly including: a case having an accommodation space formed therein; a plurality of cells positioned in the accommodation space and aligned in one direction; a plurality of sensors configured to measure at least one of voltage or temperature of at least some of the cells; a fire extinguishing pipe connected to a fire extinguishing device, at least a part of the fire extinguishing pipe being positioned in the accommodation space; a heating member positioned adjacent to the fire extinguishing pipe; and a controller configured to control a power source to apply current to the heating member based on information associated with the cells received from the sensors.

In some embodiments, the heating member includes at least one of a heating tape or a heating wire.

In some embodiments, the fire extinguishing pipe is positioned along an extension direction of the cells.

In some embodiments, the heating member is wound around at least a part of the fire extinguishing pipe.

In some embodiments, the heating member is attached along an extension direction of the fire extinguishing pipe.

In some embodiments, the fire extinguishing pipe includes a fire extinguishing agent that is discharged from the fire extinguishing device.

In some embodiments, the cells include a first group of cells and a second group of cells aligned in the one direction, and wherein the fire extinguishing pipe is positioned between the first group of cells and the second group of cells.

In some embodiments, the fire extinguishing pipe includes: a connecting pipe positioned outside the case; and a fire extinguishing tube connected to the connecting pipe and positioned in the accommodation space.

In some embodiments, the heating member is in contact with the fire extinguishing tube.

In some embodiments, a heating temperature of the heating member is higher than a melting point of the fire extinguishing tube.

In some embodiments, based on the controller applying current to the heating member, the fire extinguishing tube is melted by heat generated from the heating member, so that a fire extinguishing agent discharged from the fire extinguishing device is supplied to at least some of the cells through the fire extinguishing tube.

According to some embodiments of the present disclosure, there is provided a battery system including: a plurality of battery assemblies; a fire extinguishing device connected to the battery assemblies; and a battery management system (BMS) configured to control the battery assemblies and the fire extinguishing device, wherein each of the battery assemblies includes: a case having an accommodation space formed therein; a plurality of cells positioned in the accommodation space and aligned in one direction; a plurality of sensors configured to measure at least one of voltage or temperature of at least some of the cells; a fire extinguishing pipe connected to a fire extinguishing device and positioned in the accommodation space; a heating member positioned adjacent to the fire extinguishing pipe; and a controller configured to control a power source to apply current to the heating member based on information associated with the cells received from the sensors.

In some embodiments, the fire extinguishing device includes an agent container configured to discharge a fire extinguishing agent to the fire extinguishing pipe, and a capacity of the agent container is determined based on at least one of a capacity or a fire extinguishing area of the battery assemblies.

In some embodiments, the fire extinguishing device further includes a spray device connected to the agent container, and wherein the fire extinguishing agent discharged from the agent container is transported to the fire extinguishing pipe and the spray device.

In some embodiments, the battery management system is configured to: receive information associated with the cells from each of the battery assemblies; detect a fire occurring in at least some of the battery assemblies based on the information associated with the cells; and control the fire extinguishing device so that a fire extinguishing agent is supplied to a fire extinguishing pipe associated with one of the battery assemblies where the fire is detected.

In some embodiments, the battery management system is configured to transmit a control signal for applying current to the heating member to the controller of the battery assembly where the fire is detected.

In some embodiments, the battery management system is configured to output information associated with the battery assembly where the fire is detected.

In some embodiments, the heating member is wound around at least a part of the fire extinguishing pipe.

According to some embodiments of the present disclosure, there is provided a battery system fire extinguishing method including: receiving, by a battery management system, information associated with cells from each of a plurality of battery assemblies including a plurality of cells aligned in one direction; detecting, by the battery management system, a fire occurring in at least some of the battery assemblies based on the information associated with the cells; and controlling, by the battery management system, a fire extinguishing device to supply a fire extinguishing agent to a battery assembly where a fire is detected, each of the battery assemblies includes: a plurality of sensors configured to measure at least one of voltage or temperature of at least some of the cells; a fire extinguishing pipe connected to a fire extinguishing device and positioned in a direction parallel to the aligned cells; a heating member positioned adjacent to the fire extinguishing pipe; and a controller configured to control a power source to apply current to the heating member based on information associated with the cells received from the sensors.

In some embodiments, the heating member is wound around at least a part of the fire extinguishing pipe, and the battery system fire extinguishing method further includes transmitting, by the battery management system, a control signal for applying current to the heating member to the controller of one of the battery assemblies where the fire is detected.

According to some embodiments of the present disclosure, a fire may be extinguished in an early stages by detecting the fire in advance and spraying an extinguishing agent before thermal runaway occurs due to the fire. Accordingly, thermal runaway may be prevented from spreading to adjacent cells or the likelihood thereof may be substantially reduced, thereby reducing (e.g., minimizing) damage caused by fire.

According to some embodiments of the present disclosure, by operating the fire extinguishing device on the battery assembly where a fire has occurred, the fire extinguishing pipe of the battery assembly where a fire has not occurred may be reused. In addition, because the fire extinguishing pipe and the spray device of the battery assembly are connected, when a fire occurs in the battery assembly, the fire may be extinguished concurrently (e.g., simultaneously) inside and outside the battery assembly. Accordingly, damage caused by fire may be reduced.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a battery cell according to some embodiments of the present disclosure;

FIG. 2 illustrates a cross-sectional view of a battery cell according to some embodiments of the present disclosure;

FIG. 3 illustrates an exploded perspective view of a battery assembly according to some embodiments of the present disclosure;

FIG. 4 illustrates a perspective view of the exterior of a case provided with a fire extinguishing pipe, according to some embodiments of the present disclosure;

FIG. 5 illustrates a perspective view of a state in which a fire extinguishing pipe is positioned inside a case, according to some embodiments of the present disclosure;

FIG. 6 illustrates a state in which a fire extinguishing agent is sprayed in a fire extinguishing pipe according to some embodiments of the present disclosure;

FIG. 7 illustrates a heating member in contact with a fire extinguishing tube according to some embodiments of the present disclosure;

FIG. 8 illustrates a heating member in contact with a fire extinguishing tube according to some embodiments of the present disclosure;

FIG. 9 illustrates a configuration of a battery management module according to some embodiments of the present disclosure;

FIG. 10 illustrates a battery system according to some embodiments of the present disclosure; and

FIG. 11 illustrates a flowchart showing a battery system fire extinguishing method according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure. ” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein Is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein.

Accordingly, Applicant reserves the right to amend this specification, including the claims, to expressly recite any sub-range subsumed within the ranges expressly recited herein. All such ranges are Intended to be Inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

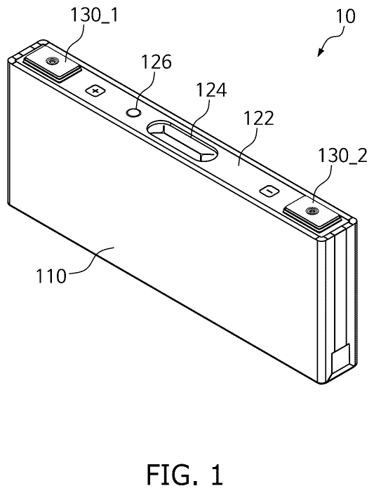

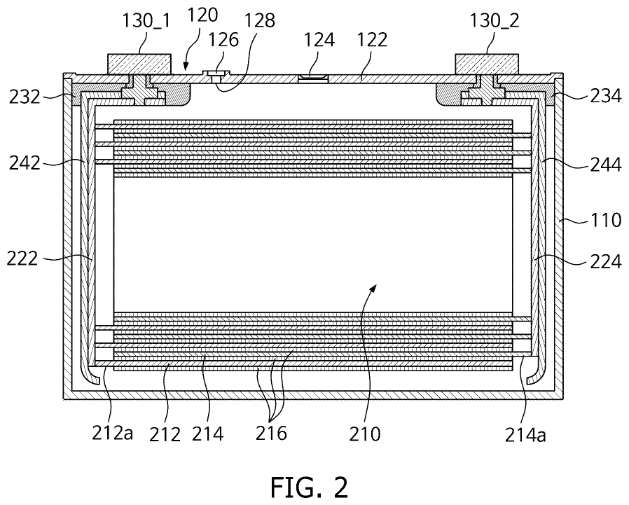

FIG. 1 illustrates a battery cell 10 according to some embodiments of the present disclosure. FIG. 2 illustrates a cross-sectional view of the battery cell 10 according to some embodiments of the present disclosure.

Referring to FIGS. 1 and 2, the secondary battery 10 according to one or more embodiments of the present disclosure may include at least one electrode assembly 210 wound with a separator 216 as an insulator between the positive electrode 212 and the negative electrode 214, a case 110 in which the electrode assembly 210 is received (or accommodated) therein, and a cap assembly 120 coupled to an opening of the case 110.

The secondary battery 10 according to one or more embodiments illustrated in FIGS. 1 and 2 will now be described as an example of a prismatic lithium ion secondary battery. However, the present disclosure is not limited thereto, and suitable aspects, features and principles described herein may be applied to various other types of batteries, such as lithium polymer batteries and/or cylindrical batteries.

Each of the positive electrode 212 and the negative electrode 214 may include a current collector made of a thin metal foil having a coated portion on which an active material is coated and an uncoated portion 212a, 214a on which an active material is not coated.

The positive electrode 212 and the negative electrode 214 are wound after interposing the separator 216, which is an insulator, therebetween. However, the present disclosure is not limited thereto, and the electrode assembly 210 may have a structure in which a positive electrode 212 and a negative electrode 214, each made of a plurality of sheets, are alternately stacked with a separator interposed therebetween.

The case 110 may form the overall outer appearance of the secondary battery 10 and may be made of a conductive metal, such as aluminum, aluminum alloy, or nickel-plated steel. In addition, the case 110 may provide a space in which the electrode assembly 210 is accommodated.

The cap assembly 120 may include a cap plate 122 covering an opening in the case 110, and the case 110 and the cap plate 122 may be made of a conductive material. The positive and negative electrode terminals 130_1 and 130_@ electrically connected to the positive electrode 212 and the negative electrode 214, respectively, may be installed to penetrate (or extend through) the cap plate 122 and protrude outwardly therethrough.

In addition, the present disclosure is not limited thereto, and the positive and negative electrode terminals 130_1 and 130_2 may have a rivet structure and may be riveted or welded to the cap plate 122.

In addition, the cap plate 122 may be made of a thin plate and may be coupled to the opening in the case 110, and an electrolyte injection port 128 into which a sealing stopper 126 may be installed may be located (e.g., formed) in the cap plate 122, and a vent portion 124 having a notch may be installed.

The positive and negative electrode terminals 130_1 and 130_2 may be electrically connected to current collectors including first and second current collectors 222 and 224 (hereinafter referred to as positive and negative current collectors) by being bonded or coupled (e.g., by welding) to the positive uncoated portion 212a and the negative electrode uncoated portion 214a, respectively.

For example, the positive and negative electrode terminals 130_1 and 130_2 may be coupled by welding to the positive and negative electrode current collectors 222 and 224, respectively. However, the present disclosure is not limited thereto, and the positive and negative electrode terminals 130_1 and 130_2 and the positive and negative electrode current collectors 222 and 224 may be integrally formed in one or more embodiments.

In addition, an insulation member may be installed between the electrode assembly 210 and the cap plate 122. The insulation member may include first and second lower insulation members 232 and 242, and each of the first and second lower insulation members 232 and 242 may also have a portion located between the electrode assembly 210 and the case 110.

In addition, according to one or more embodiments of the present disclosure, one end of a separation member may face one side of the electrode assembly 210 and may be installed between the insulation member and the positive or negative electrode terminals 130_1 and 130_2. In one or more embodiments, the separation member may include first and second separation members 242 and 244.

In such some embodiments, first ends of the first and second separation members 242 and 244 installed to face one side of the electrode assembly 21 may be respectively installed between the first and second lower insulation members 232 and 234 and the positive and negative electrode terminals 130_1 and 130_2.

Accordingly, the positive and negative electrode terminals 130_1 and 130_2, which may be coupled by welding to the positive and negative electrode current collectors 222 and 224, may be coupled to first ends of the first and second lower insulation members 232 and 234 and the first and second separation members 242 and 244.

The battery cell 10 may be a lithium battery cell, a sodium battery cell, or the like. However, the scope of the present disclosure is not limited thereto, and the battery cell 10 includes any battery that is capable of repeatedly providing electricity through charging and discharging. In some embodiments, the battery cell 10 is a lithium battery cell, which may be used in electric vehicles (EVs) because the lithium battery cell has excellent lifespan characteristics and high rate characteristics. For example, the lithium battery cell may be used in EVs such as plug-in hybrid electric vehicles (PHEVs). In addition, the lithium battery cell may be used in fields that require a large amount of power storage. For example, the lithium battery cell may be used in an electric bicycle, a power tool, and an energy storage system (ESS).

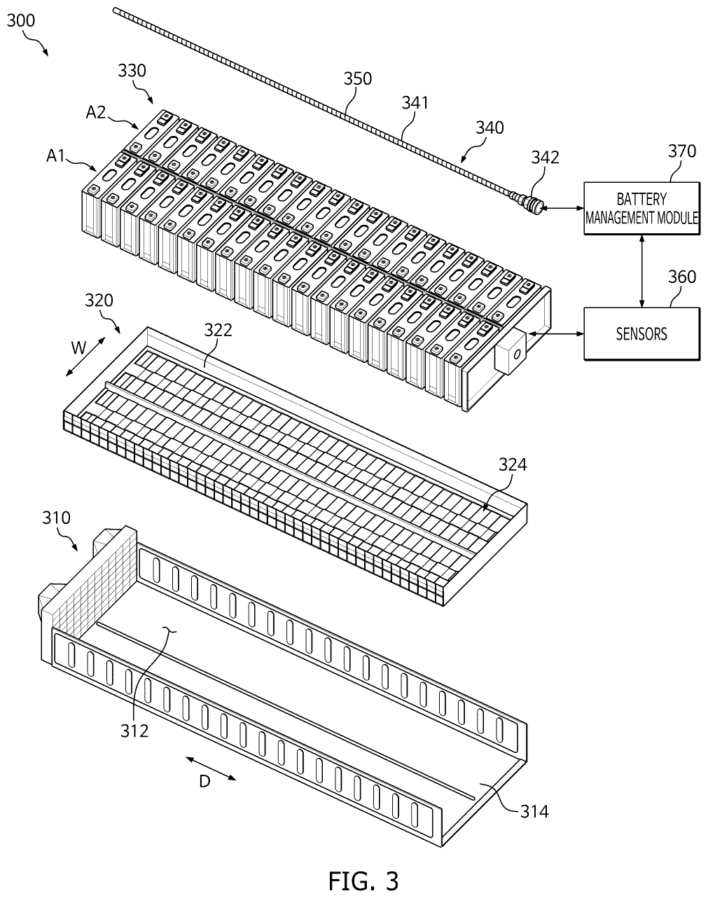

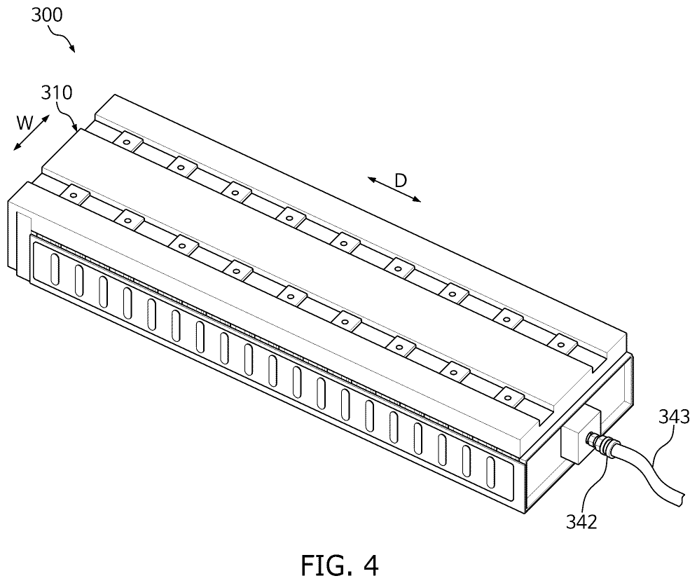

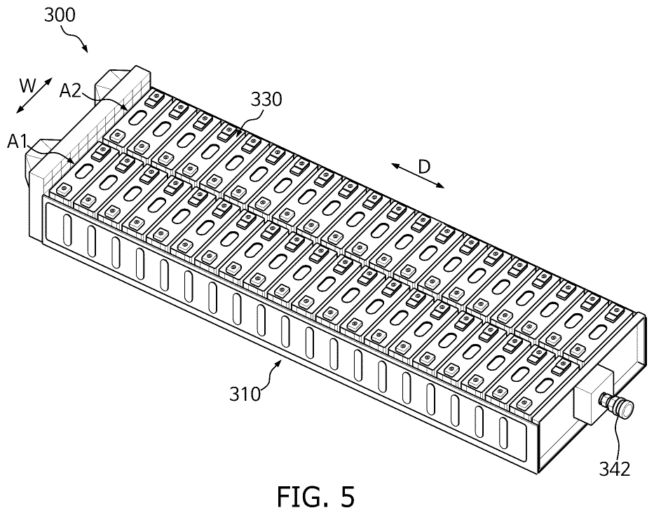

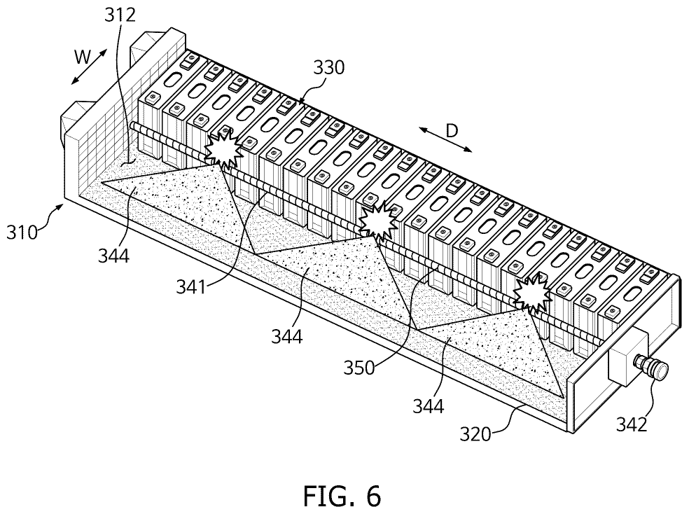

FIG. 3 illustrates an exploded perspective view of a battery assembly 300 according to some embodiments of the present disclosure. FIG. 4 illustrates a perspective view of the exterior of a case 310 provided with a fire extinguishing pipe 340, according to some embodiments of the present disclosure. FIG. 5 illustrates a perspective view of a state in which the fire extinguishing pipe 340 is positioned inside the case 310, according to some embodiments of the present disclosure. and FIG. 6 illustrates a state in which a fire extinguishing agent is sprayed in the fire extinguishing pipe 340 according to some embodiments of the present disclosure.

Referring to FIG. 3, the battery assembly 300 according to some embodiments of the present disclosure may include a case 310 having an accommodation space 312 provided therein, a plurality of cells 330 (such as the battery cells of FIG. 1) positioned in the accommodation space 312 and aligned in one direction (e.g., in the longitudinal direction D of the case 310), a fire extinguishing pipe 340 connected to a fire extinguishing device and having at least a part of the fire extinguishing pipe positioned in the accommodation space 312, and a heating member 350 positioned adjacent to (or attached to) the fire extinguishing pipe. The longitudinal direction D of the case 310 may refer to a direction parallel to a longer portion with respect to the upper surface of the case 310. The width direction W of the case 310 may refer to a direction parallel to a short portion with respect to the upper surface of the case 310.

In some embodiments, the cells 330 may be circular, prismatic, pouch cells, etc., and are not limited in type and shape. In some embodiments, the accommodation space 312 of the case 310 may be transformed into various sizes and shapes depending on the type and shape of the cell 330.

In some embodiments, the fire extinguishing pipe 340 may be positioned along the extension direction (i.e., the direction D) of the aligned cells 330. In some embodiments, the cells 330 may include a first group of cells A1 and a second group of cells A2 aligned in one direction (i.e., in the direction D). In such examples, the fire extinguishing pipe 340 may be positioned between the first group of cells A1 and the second group of cells A2. The fire extinguishing pipe 340 may be positioned on the side, bottom, or top of the cells 330.

In some embodiments, the fire extinguishing pipe 340 may contain a fire extinguishing agent to be discharged from the fire extinguishing device. The fire extinguishing pipe 340 may include a connecting pipe 142 positioned outside the case 310 and a fire extinguishing tube 341 connected to the connecting pipe 142 and positioned in the accommodation space 312.

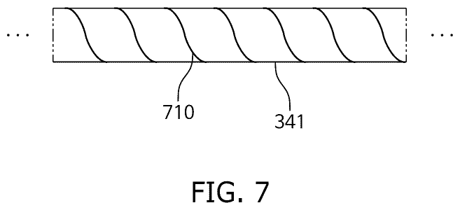

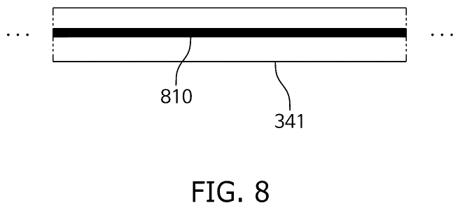

In some embodiments, the heating member 350 may be positioned adjacent to the fire extinguishing pipe 340. For example, the heating member 350 may be wound around at least a part of the fire extinguishing pipe 340. In another example, the heating member 350 may be attached along the extension direction (i.e., the direction D) of the fire extinguishing pipe 340. In some other embodiments, the heating member 350 may come into contact with the fire extinguishing tube 341. An example in which the heating member 350 is positioned adjacent to the fire extinguishing pipe 340 is described in detail below with reference to FIGS. 7 and 8.

In some embodiments, the heating temperature of the heating member 350 may be higher than the melting point of the fire extinguishing tube 341. Accordingly, the fire extinguishing tube 341 may be melted at a temperature higher than the melting point by the heating temperature of the heating member 350, and the fire extinguishing agent contained in the fire extinguishing tube 341 may be discharged into the accommodation space 312 of the case 310. In some embodiments, the heating member 350 may include at least one of a heating tape or a heating wire, but the present disclosure is not limited thereto.

In some embodiments, the battery assembly 300 may further include a plurality of sensors 360 respectively connected to the cells and a battery management module 370. The sensors 360 may measure at least one of the voltage or temperature of at least some of the cells 330. In addition, the battery management module 370 (e.g., a controller included in the battery management module) may control power to apply current to the heating member 350 based on information associated with the cells received from the sensors 360.

In some embodiments, the battery assembly 300 may further include a lower panel 320 installed between a lower plate 314 of the case 310 and the cells 330 to support the lower parts of the cells 330. The lower panel 320 may block the melted fire extinguishing agent discharged from the fire extinguishing pipe 340 from moving to the lower plate 314. In some embodiments, the lower panel 320 may include a frame member 322 that protrudes upward from the frame of the lower plate 314 of the case 310 and a panel body 324 to support the side surfaces of the cells 330 or the battery modules.

Referring to FIG. 4, the fire extinguishing pipe 340 may be positioned in the accommodation space 312 of the case 310. The fire extinguishing pipe 340 may include a supply pipe 343 positioned outside the case 310 and supplying a fire extinguishing agent from a fire extinguishing supply source (e.g., a fire extinguishing agent container), a connecting pipe 342 positioned outside the case 310 and connected to the supply pipe 343, and a fire extinguishing tube 341 connected to the connecting pipe 342 and positioned in the accommodation space 312.

In some embodiments, the fire extinguishing tube 341 may have a tube shape with a sealed interior, but the present disclosure is not limited thereto. The fire extinguishing tube 341 has an inner diameter and an outer diameter due to the thickness of the material. In some examples, the entire thickness from the inner diameter of the fire extinguishing tube 341 to the outer diameter thereof is melted, thereby forming a through hole in the outer surface of the fire extinguishing tube 341 through which the fire extinguishing agent may be discharged. To this end, the heating temperature of the heating member 350 may be higher than the melting point of the fire extinguishing tube 341. For example, the melting point of the fire extinguishing tube 341 may be 80° C. to 300° C., but the present disclosure is not limited thereto, and the melting point of the fire extinguishing tube 341 may vary depending on the material of the fire extinguishing tube 341.

In some embodiments, the fire extinguishing agent is not limited in type as long as the fire extinguishing agent is a material capable of extinguishing a fire caused by thermal runaway of the cells 330. For example, the fire extinguishing agent may include solid, liquid and gaseous materials having a cooling effect. The gaseous material may include a carbon dioxide extinguishing agent and a halogen extinguishing agent, the solid material may include a phosphate extinguishing agent and a bicarbonate extinguishing agent, and the liquid material may include an acid-alkali extinguishing agent, a strengthened liquid extinguishing agent, and a foam extinguishing agent. For example, the fire extinguishing agent may be any one of heptafluoropropane, a water-based extinguishing agent for cooling fire extinguishment, and 1,1,1,2,3,3,3-hexafluoropropane. In addition, an appropriate fire extinguishing agent may be determined based on the cell capacity so as to prevent or substantially reduce the likelihood of a thermal runaway transition.

In some embodiments, the material of the fire extinguishing tube 341 is not particularly limited as long as the material of the fire extinguishing agent is a material that can melt at the heating temperature of the heating member 350. For example, the material of the fire extinguishing tube 341 may include at least one of polypropylene (PP), linear low density polyethylene (LLDPE), polyvinyl chloride (PVC), polyamide 6 (PA6), and polyamide 66 (PA66).

Referring to FIG. 5, the cells 330 may be positioned side-by-side along the longitudinal direction D of the case 310. There is no limitation on the number of cells 330 positioned side-by-side along the longitudinal direction D of the case 310, and the cells 330 may be positioned side-by-side to form the first group of cells A1 and the second group of cells A2. In another example, the cells 330 may include three or more cell groups positioned side-by-side. In addition, the cells 330 may be arranged as shown in FIG. 5, but the arrangement form is not limited thereto.

In some embodiments, the cells 330 may include the first group of cells A1 and the second group of cells A2 spaced apart at a certain interval along the width direction W of the case 310. In such examples, the fire extinguishing pipe 340 may be positioned between the first group of cells A1 and the second group of cells A2. Accordingly, the certain interval between the first group of cells A1 of the second group of cells A2 may refer to an interval at which the fire extinguishing pipe 340 can be positioned.

Referring to FIG. 6, the fire extinguishing tube 341 may be spaced apart from the side surfaces of the cells 330 by a certain interval and may extend along the longitudinal direction D of the case 310. The fire extinguishing tube 341 may be positioned on the side, bottom, or top of the cells 330.

In some embodiments, the heating member 350 may come into contact with the fire extinguishing tube 341. For example, the heating member 350 may be wound around the fire extinguishing tube 341. In a situation where the heating member 350 generates heat, the fire extinguishing tube 341 with which the heating member 350 comes into contact may melt. Accordingly, the fire extinguishing agent 344 may be sprayed from the fire extinguishing tube 341.

With this configuration, a fire may be extinguished in an early stages by detecting the fire in advance and spraying an extinguishing agent before thermal runaway occurs due to the fire. Accordingly, thermal runaway may be prevented from spreading to adjacent cells or the likelihood thereof may be substantially reduced, thereby reducing (e.g., minimizing) damage caused by fire.

FIG. 7 illustrates a heating member 710 in contact with a fire extinguishing tube 341 according to some embodiments of the present disclosure. In some embodiments, the heating member 710 may come into contact with the fire extinguishing tube 341. The heating member 710 may include at least one of a heating tape or a heating wire. In some examples, the heating member 710 may be spirally wound around the fire extinguishing tube 341. In such examples, the fire extinguishing tube 341 may be melted due to the heating member 710, and thus, the fire extinguishing agent inside the fire extinguishing tube 341 may be sprayed in all directions.

FIG. 8 illustrates a heating member 810 in contact with a fire extinguishing tube 341 according to some embodiments of the present disclosure. In some embodiments, the heating member 810 may come into contact with the fire extinguishing tube 341. The heating member 810 may include at least one of a heating tape or a heating wire. In some examples, the heating member 810 may be attached along the extension direction of the fire extinguishing tube 341. In FIG. 8, the heating member 810 is shown as being attached to the side of the fire extinguishing tube 341, but the present disclosure is not limited thereto, and the heating member 810 may be attached to the upper or lower part of the fire extinguishing tube 341. In such examples, the fire extinguishing tube 341 may be melted due to the heating member 710, and thus, the fire extinguishing agent inside the fire extinguishing tube 341 may be sprayed in the direction in which the heating member 810 is attached to the fire extinguishing tube 341. For example, in a situation where the heating member 810 is attached to the side of the fire extinguishing tube 341, the fire extinguishing agent may be sprayed to the side.

In FIG. 8, only one heating member 810 is shown, but the present disclosure is not limited thereto, and a plurality of heating members 810 may be attached to the fire extinguishing tube 341.

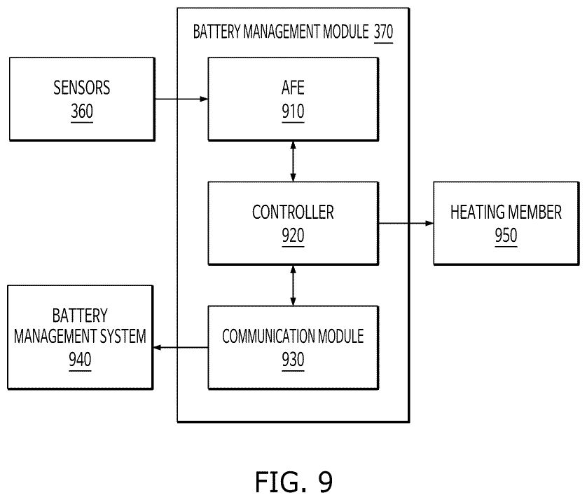

FIG. 9 illustrates a configuration of a battery management module 370 according to some embodiments of the present disclosure. In some embodiments, the battery management module 370 may be configured to transmit states of a plurality of cells collected through a plurality of sensors 360 to a battery management system 940 and/or other battery management modules. To this end, the battery management module 370 may include an analog front end (AFE) (910), a controller 920, and a communication module 930.

In some embodiments, the battery management module 370 may be connected to the cells and configured to monitor the states of the cells. For example, the battery management module 370 may be connected to a plurality of sensors 360 that measure at least one of current, voltage, or temperature of at least some of the cells and may obtain data associated with the states of the cells.

In some embodiments, the AFE 910 may measure the states of the cells (e.g., current, voltage, and temperature), which are analog signals, and convert the states into digital signals. For example, the AFE 910 may measure the states of the cells (e.g., current, voltage, and temperature), which are analog signals, from the sensors 360 and convert the states into digital signals.

In some embodiments, the controller 920 may monitor the states of the cells based on state information (e.g., voltage, current, and temperature) of each of the cells received from the AFE 910. For example, the controller 920 may determine whether the battery cell is in an overvoltage or overheat state based on at least one of state information (e.g., voltage, current, and temperature) of each of the cells.

According to some embodiments, the battery management module 370 may transmit state information and fire occurrence information of the cells to the battery management system 940. For example, the controller 920 may transmit state information and fire occurrence information of the cells to the battery management system 940 through the communication module 640. The communication module 930 may include, for example, at least one of a controller area network (CAN) communication circuit or a radio frequency (RF) circuit, but the present disclosure is not limited thereto.

In some embodiments, the battery management system 940 may receive information associated with the cells (e.g., state information of the cells, etc.) from the battery management module 370. In such examples, the battery management system 940 may detect a fire occurring in the battery assembly associated with the battery management module 370 based on information associated with the cells. Accordingly, the battery management system 940 may control the fire extinguishing device to supply the fire extinguishing agent to the fire extinguishing pipe associated with the battery assembly where a fire is detected. In some embodiments, the battery management system 940 may transmit a control signal for applying current to the heating member 950 to the controller 920 through the communication module 930. The controller 920 may control a power source to apply current to the heating member 950 so that the heating member 950 generates heat, in response to receiving the control signal from the battery management system 940.

In some embodiments, the resistance of the battery management module 370 may be replaced with the resistance of the heating member 950. In such examples, the heating member 950 may be a heating wire. Accordingly, the internal resistance of the battery management module 370 is omitted, and the heating member 950 may act as the resistor of the battery management module 370.

Although FIG. 9 illustrates that the battery management system 940 detects a fire occurring in the battery assembly and transmits a control signal for applying current to the heating member 950 to the battery management module 370, the present disclosure is not limited thereto. For example, the battery management module 370 may detect a fire in the battery assembly based on information associated with the cells and generate a control signal for applying current to the heating member 950.

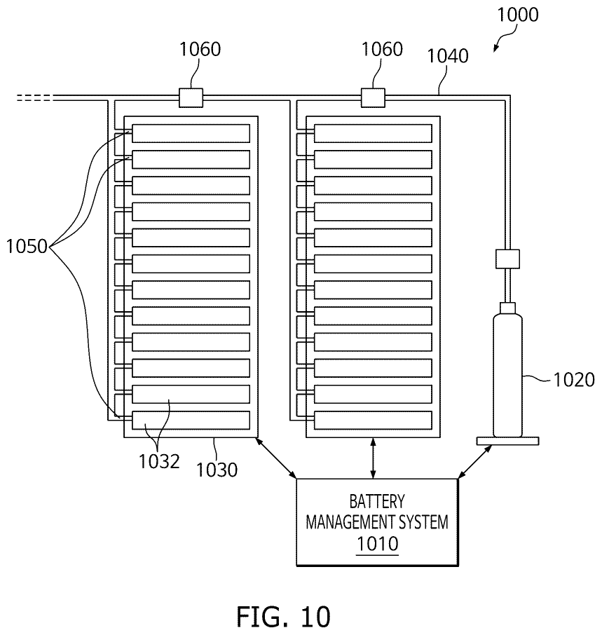

FIG. 10 illustrates a battery system 1000 according to some embodiments of the present disclosure. In some embodiments, the battery system 1000 may include a fire extinguishing device connected to a plurality of battery assemblies 1032 so as to respond to an event (e.g., a fire) occurring in the battery cells. Prior to the description of the fire extinguishing device, the battery system 1000 is briefly described.

According to some embodiments, the battery system 1000 may include a plurality of battery assemblies 1032 and at least one battery rack 1030 in which the battery assemblies 1032 are accommodated. A plurality of battery cells may be accommodated within the case of each of the battery assemblies 1032.

In some embodiments, the battery system 1000 may include a battery management system 1010. The battery management system 1010 may be connected to the battery management modules (e.g., 370 of FIG. 3) included in each of the battery assemblies 1032. In some embodiments, the battery management system 1010 may comprehensively monitor and manage all the battery assemblies 1032 included in the battery system 1000.

In some embodiments, the battery management system 1010 may receive information associated with the cells from each of the battery assemblies 1032. In some embodiments, the battery management system 1010 may detect a fire that has occurred in at least some of the battery assemblies 1032 based on information associated with the cells. In some embodiments, the battery management system 1010 may control the fire extinguishing device to supply the fire extinguishing agent to the fire extinguishing pipe associated with the battery assembly where a fire is detected. The battery management system 1010 may output information associated with the battery assembly in which a fire is detected (e.g., identification information, location, etc. of the battery assembly where a fire is detected).

In some embodiments, the battery system 1000 may include a fire extinguishing device. The battery management system 1010 may operate a fire extinguishing device in response to a detection signal and/or detection data for each battery cell so as to respond to an event (e.g., vent gas discharge, fire occurrence, etc.) occurring in the battery cells included in the battery system 1000.

In some embodiments, the fire extinguishing device may include an agent container 1020, a main pipe 1040, a branch pipe 1050 connected to the fire extinguishing pipe (e.g., 340 of FIG. 3) of each of the battery assemblies 1032, and a spray device 1060. For example, the agent container 1030 may be a type of storage container that stores a fire extinguishing agent. The agent container 1030 may be a pressure container that stores high-pressure fire extinguishing agent and discharges the fire extinguishing agent to the fire extinguishing pipe through the main pipe and the branch pipe. In some embodiments, the capacity of the agent container 1030 may be determined based on at least one of the capacity or the fire extinguishing area of the battery assemblies 1032. The fire extinguishing agent may be stored in the fire extinguishing agent container 1030 in a compressed or pressurized manner.

In some embodiments, in a situation where the spraying of the fire extinguishing agent from the high-pressure agent container 1030 is determined, a main valve of the agent container 1030 may be opened to spray the fire extinguishing agent. The main valve of the agent container 1030 may have the function of opening and closing the discharge portion of the agent container. For example, the main valve of the agent container 1030 may control the supply or the supply stop of the fire extinguishing agent according to a command of the battery management system 1010. In some embodiments, in a situation where the main valve is opened, the fire extinguishing agent may be discharged from the agent container 1030 and transported through the main pipe 1040.

In some embodiments, the main pipe 1040 may extend from the agent container 1030 to transport the fire extinguishing agent toward each battery rack 1030. The main pipe 1040 may be placed/installed adjacent to the outside of each of the battery racks 1030. Referring to FIG. 10, the main pipe 1040 may be installed adjacent to the battery rack 1030 so as to extend parallel to the direction in which the battery assemblies 1032 are aligned within the battery rack 1030. In some other embodiments, the main pipe 1040 may be installed to be branched so as to be inserted into each of the battery racks 1030. In such examples, the main pipe 1040 may extend in a direction parallel to the direction in which the battery assembly 1032 is aligned within the battery rack 1030 and may be installed in an upper area within the battery rack 1030.

In some embodiments, the main pipe 1040 may be branched into branch pipes 1050 respectively connected to the battery assemblies 1032 included in the battery rack 1030. The branch pipes 1050 may be respectively connected to the battery assemblies 1032 included in the battery rack 1030. In some embodiments, the branch pipes 1050 may be connected to a fire extinguishing pipe extending in a direction parallel to the direction in which the battery cells are aligned within the battery assembly 1032. The branch pipes 1050 may include valves, and the valves of the branch pipes 1050 may control the supply or the supply stop of the fire extinguishing agent to the battery assembly 1032 according to a command from the battery management system 1010.

In some embodiments, the spray device 1060 may be connected to the main pipe 1040. In some embodiments, the spray device 1060 may be positioned above the battery rack 1030. The spray device 1060 may include valves, and the valves of the spray device 1060 may control the supply or the supply stop of the fire extinguishing agent to the battery rack 1030 according to a command from the battery management system 1010. In other words, in a situation where the battery management system 1010 detects that a fire has occurred in a specific battery assembly, the fire extinguishing agent discharged from the agent container 1020 may be transported and sprayed along the main pipe 1040 and the branch pipe 1050 to the fire extinguishing pipe of the specific battery assembly, and at the same time, may be transported and sprayed to the spray device 1060 adjacent to the specific battery rack including the specific battery assembly.

The number of battery racks 1030 and the battery assemblies 1032 included in the battery system 1000 is not particularly limited, and there is no limitation on the arrangement of the battery racks 1030 and the battery assemblies 1032.

With this configuration, by operating the fire extinguishing device on the battery assembly where a fire has occurred, the fire extinguishing pipe of the battery assembly where a fire has not occurred may be reused. In addition, because the fire extinguishing pipe and the spray device of the battery assembly are connected, in a situation where a fire occurs in the battery assembly, the fire may be extinguished concurrently (e.g., simultaneously) inside and outside the battery assembly. Accordingly, damage caused by fire may be reduced.

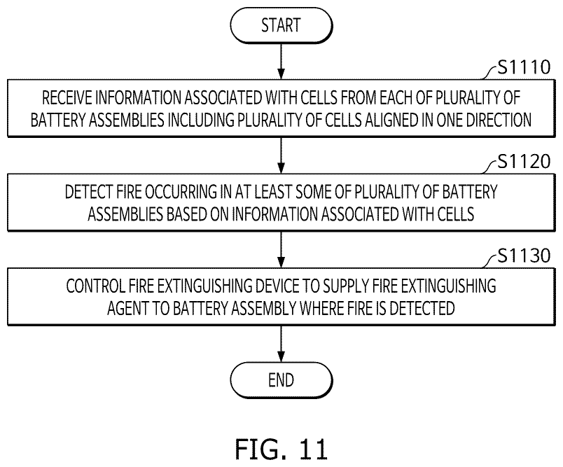

FIG. 11 illustrates a flowchart showing a battery system fire extinguishing method 1100 according to some embodiments of the present disclosure. In some embodiments, the battery system fire extinguishing method 1100 may be initiated by an operation in which a battery management system receives information associated with cells from each of a plurality of battery assemblies including a plurality of cells aligned in one direction (S1110). Each of the battery assemblies may include a plurality of sensors that measure at least one of a voltage or a temperature of at least some of the cells, a fire extinguishing pipe connected to a fire extinguishing device and positioned in a direction parallel to the aligned cells, a heating member positioned adjacent to the fire extinguishing pipe, and a controller that controls power to apply current to the heating member based on information associated with the cells received from the sensors.

Thereafter, the battery management system may detect a fire occurring in at least some of the battery assemblies based on information associated with the cells (S1120). In some embodiments, the battery management system may control a fire extinguishing device to supply a fire extinguishing agent to a battery assembly where a fire is detected (S1130).

In some embodiments, the heating member may be wound around at least a part of the fire extinguishing pipe. In some embodiments, the battery management system may transmit a control signal for applying current to the heating member to the controller of the battery assembly in which a fire is detected. In addition, the battery management system may output information associated with the battery assembly where a fire is detected.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME OF THE SYMBOLS

10: battery cell
110: case
122: cap plate
124: vent portion
126: sealing stopper
130_1: positive electrode terminal
130_2: negative electrode terminal

What is claimed is:

1. A battery assembly comprising:
a case having an accommodation space formed therein;
a plurality of cells positioned in the accommodation space and aligned in one direction;
a plurality of sensors configured to measure at least one of voltage or temperature of at least some of the cells;
a fire extinguishing pipe connected to a fire extinguishing device, at least a part of the fire extinguishing pipe being positioned in the accommodation space;
a heating member positioned adjacent to the fire extinguishing pipe; and
a controller configured to control a power source to apply current to the heating member based on information associated with the cells received from the sensors.

2. The battery assembly as claimed in claim 1, wherein the heating member comprises at least one of a heating tape or a heating wire.

3. The battery assembly as claimed in claim 1, wherein the fire extinguishing pipe is positioned along an extension direction of the cells.

4. The battery assembly as claimed in claim 1, wherein the heating member is wound around at least a part of the fire extinguishing pipe.

5. The battery assembly as claimed in claim 1, wherein the heating member is attached along an extension direction of the fire extinguishing pipe.

6. The battery assembly as claimed in claim 1, wherein the fire extinguishing pipe comprises a fire extinguishing agent that is discharged from the fire extinguishing device.

7. The battery assembly as claimed in claim 1, wherein the cells comprise a first group of cells and a second group of cells aligned in the one direction, and
wherein the fire extinguishing pipe is positioned between the first group of cells and the second group of cells.

8. The battery assembly as claimed in claim 7, wherein the fire extinguishing pipe comprises:
a connecting pipe positioned outside the case; and
a fire extinguishing tube connected to the connecting pipe and positioned in the accommodation space.

9. The battery assembly as claimed in claim 8, wherein the heating member is in contact with the fire extinguishing tube.

10. The battery assembly as claimed in claim 8, wherein a heating temperature of the heating member is higher than a melting point of the fire extinguishing tube.

11. The battery assembly as claimed in claim 10, wherein, based on the controller applying current to the heating member, the fire extinguishing tube is melted by heat generated from the heating member, so that a fire extinguishing agent discharged from the fire extinguishing device is supplied to at least some of the cells through the fire extinguishing tube.

12. A battery system comprising:
a plurality of battery assemblies;
a fire extinguishing device connected to the battery assemblies; and
a battery management system (BMS) configured to control the battery assemblies and the fire extinguishing device,
wherein each of the battery assemblies comprises:
a case having an accommodation space formed therein;
a plurality of cells positioned in the accommodation space and aligned in one direction;
a plurality of sensors configured to measure at least one of voltage or temperature of at least some of the cells;
a fire extinguishing pipe connected to a fire extinguishing device and positioned in the accommodation space;
a heating member positioned adjacent to the fire extinguishing pipe; and
a controller configured to control a power source to apply current to the heating member based on information associated with the cells received from the sensors.

13. The battery system as claimed in claim 12, wherein the fire extinguishing device comprises an agent container configured to discharge a fire extinguishing agent to the fire extinguishing pipe, and
wherein a capacity of the agent container is determined based on at least one of a capacity or a fire extinguishing area of the battery assemblies.

14. The battery system as claimed in claim 13, wherein the fire extinguishing device further comprises a spray device connected to the agent container, and
wherein the fire extinguishing agent discharged from the agent container is transported to the fire extinguishing pipe and the spray device.

15. The battery system as claimed in claim 12, wherein the battery management system is configured to:
receive information associated with the cells from each of the battery assemblies;
detect a fire occurring in at least some of the battery assemblies based on the information associated with the cells; and
control the fire extinguishing device so that a fire extinguishing agent is supplied to a fire extinguishing pipe associated with one of the battery assemblies where the fire is detected.

16. The battery system as claimed in claim 15, wherein the battery management system is configured to transmit a control signal for applying current to the heating member to the controller of the battery assembly where the fire is detected.

17. The battery system as claimed in claim 15, wherein the battery management system is configured to output information associated with the battery assembly where the fire is detected.

18. The battery system as claimed in claim 12, wherein the heating member is wound around at least a part of the fire extinguishing pipe.

19. A battery system fire extinguishing method comprising:
receiving, by a battery management system, information associated with cells from each of a plurality of battery assemblies comprising a plurality of cells aligned in one direction;
detecting, by the battery management system, a fire occurring in at least some of the battery assemblies based on the information associated with the cells; and
controlling, by the battery management system, a fire extinguishing device to supply a fire extinguishing agent to a battery assembly where a fire is detected,
wherein each of the battery assemblies comprises:
a plurality of sensors configured to measure at least one of voltage or temperature of at least some of the cells;
a fire extinguishing pipe connected to a fire extinguishing device and positioned in a direction parallel to the aligned cells;
a heating member positioned adjacent to the fire extinguishing pipe; and
a controller configured to control a power source to apply current to the heating member based on information associated with the cells received from the sensors.

20. The battery system fire extinguishing method as claimed in claim 19, wherein the heating member is wound around at least a part of the fire extinguishing pipe, and
wherein the battery system fire extinguishing method further comprises transmitting, by the battery management system, a control signal for applying current to the heating member to the controller of one of the battery assemblies where the fire is detected.
